(19) United States
(12) Patent Application Publication
(10) Pub. No.: US 2024/0055971 A1
(43) Pub. Date: Feb. 15, 2024

(54) METHODS AND APPARATUS FOR MEASURING RESONANT CURRENT IN A POWER CONVERTER

(71) Applicant: Enphase Energy, Inc., Petaluma, CA (US)

(72) Inventor: Michael J. HARRISON, Petaluma, CA (US)

(21) Appl. No.: 18/230,011

(22) Filed: Aug. 3, 2023

Related U.S. Application Data
(60) Provisional application No. 63/397,982, filed on Aug. 15, 2022.

(51) Int. Cl. H02M 1/00; H02M 7/537

(52) U.S. Cl. CPC H02M 1/0009; H02M 7/537

(57) ABSTRACT

An apparatus for measuring current in a power converter is provided. The apparatus comprises a state space observer configured to provide a statistically most probable state of the power converter and an analog digital converter comprising a comparator configured to compare a first state space observer current approximation to a real time current input signal to determine if the first state space observer current approximation is too high or too low and a counter configured to be incremented or decremented based on a result of a comparison at the comparator, wherein an output of the counter is input to the state space observer and added to the first state space observer current approximation to calculate a second state space observer current approximation that will be one count closer to a final correct value.

### CROSS-REFERENCE TO RELATED APPLICATIONS

This application claims the benefit of and priority to U.S. Provisional Application Ser. No. 63/397,982, filed on Aug. 15, 2022, the entire contents of which is incorporated herein by reference.

### BACKGROUND

### Field of the Disclosure

Embodiments of the present disclosure relate generally to power conversion and, in particular, to methods and apparatus for measuring resonant current in a power converter.

### Description of the Related Art

Conventional control application specific integrated circuits (ASIC) used with microinverters, typically, include control logic for achieving power conversion (e.g., DC input power from a photovoltaic (PV) module is converted to AC power for export to a main grid). The control logic monitors a current that flows through a resonant tank (iTank) using a successive-approximation-register analog to digital converter (SAR ADC) circuit. The iTank ADC and control logic forms part of a real time control loop which effectively controls the iTank current to control the power conversion from DC to AC (or vice versa—as applicable to battery storage microinverters).

Any latency related to a real time control loop, however, can limit high frequency performance (e.g., load step performance) and, ultimately, require the control to be bandwidth limited to maintain control stability. Latency (e.g., as expressed in units of time) directly relates to phase delay (e.g., as expressed in circular units of degrees) as a function of the control frequency. For example, as the control frequency is increased, a given amount of latency represents a phase delay that increases with the control frequency. Additionally, at relatively high frequencies, the phase delay can become significant. For example, 180° of phase delay can completely invert a control action, thus causing negative feedback, which is stable and desirable, to become positive feedback, which is unstable and undesirable.

Moreover, well before reaching 180° of phase delay, any real time control loop can become unstable if the real time control loop is not bandwidth limited. Typically, a phase stability margin of at least 45 degrees is required for a real time control loop. To implement 45 degrees of phase stability margin requires a control loop gain to be bandwidth limited, i.e., the control response needs to be attenuated less than unity for 135° of phase delay (180°−135°=45° of phase stability margin). Bandwidth limiting a real time control loop can ensure the controller stability, however, bandwidth limiting does limit the responsiveness of the controller.

With the adoption of GaN HEMT devices in place of the Si Super-Junction MOSFETs a 10× increase in the switching frequency will be adopted. This increase in switching will require the existing controller to have 10× the control bandwidth in order to provide the same control responsiveness. This 10× increase in controller bandwidth will require the iTank ADC latency to be reduced by a factor of 10×.

The iTank ADC typically employed in existing microinverter control ASICs is based on a 12-bit SAR ADC design. For example, a 12-bit SAR ADC can be based on a 12-bit DAC and a successive approximation circuit which implements a binary divide based on 12 successive approximations to determine a value of the ADC input signal (e.g., iTank). The successive binary divide starts with the DAC outputting a value that represents 50%, which is compared to the input signal to determine if the first approximation is too high or too low. Thus, depending on the result of the first compare, the second approximation sent to the DAC can be 25% (e.g., 1^{st} guess too high) or 75% (e.g., 1^{st} guess too low). The resolution of each successive approximation can be divided by half each iteration, e.g., 50%, 25%, 12.5%, 6.25%, 3.125%, and so on. Based on the forgoing, a 12-bit SAR ADC can require up to 12 successive approximations to make the complete measurement of the input signal value, e.g., can take 12 clock cycles for the SAR ADC.

A method for reducing the latency of a SAR ADC by a factor of 10× can comprise increasing a clock frequency that the ADC is operated at. For example, a 100 MHz clock that the existing ADC is operated can represent a limit of a silicon, hence there is a need to find some other way to reduce the latency of the iTank ADC.

Thus, there is a need for improved methods and apparatus for measuring resonant current in a power converter.

### SUMMARY

In accordance with at least some embodiments, an apparatus for measuring current in a power converter comprises a state space observer configured to provide a statistically most probable state of the power converter and an analog digital converter comprising a comparator configured to compare a first state space observer current approximation to a real time current input signal to determine if the first state space observer current approximation is too high or too low and a counter configured to be incremented or decremented based on a result of a comparison at the comparator, wherein an output of the counter is input to the state space observer and added to the first state space observer current approximation to calculate a second state space observer current approximation that will be one count closer to a final correct value.

In accordance with at least some embodiments, a method for measuring current in a power converter comprises providing via a state space observer a statistically most probable state of the power converter, comparing at a comparator a first state space observer current approximation to a real time current input signal to determine if the first state space observer current approximation is too high or too low, one of incrementing or decrementing a counter based on a result of a comparison, and inputting an output of the counter to the state space observer and adding the output to the first state space observer current approximation to calculate a second state space observer current approximation that will be one count closer to a final correct value.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic diagram of a power conversion system comprising a switched mode power converter in accordance with embodiments of the present disclosure;

FIG. 2 is a schematic diagram of a power conversion system comprising a switched mode power converter in accordance with embodiments of the present disclosure;

FIG. 3A is a cross-sectional view depicting a structure of the switch Q in accordance with embodiments of the present disclosure;

FIG. 3B is a plan view of the switch Q in accordance with embodiments of the present disclosure;

FIG. 4 is a schematic diagram of an iTank ADC chip for measuring current in accordance with embodiments of the present disclosure;

FIG. 5 is a schematic diagram of a current transformer and external bias resistors in accordance with embodiments of the present disclosure; and

FIG. 6 is a schematic diagram of an iTank ADC chip for measuring current in accordance with embodiments of the present disclosure; and

FIG. 7 is a flowchart of a method for measuring current in a power converter in accordance with embodiments of the present disclosure.

### DETAILED DESCRIPTION

Embodiments of the present disclosure are directed to methods and apparatus for measuring resonant current in a power converter. For example, the one or more microinverters described herein use gallium nitride (GaN) HEMT (high electron mobility transistors) which enable a switching frequency to be increased by a factory of about 10× to about 1 MHz to about 2 MHz. The 10× increase in switching frequency requires a 10× reduction in the iTank ADC latency to maintain controller stability. Thus, in accordance with at least some embodiments of the disclosure, an improved iTank ADC is described herein and achieves a 10 ns latency which allows the gallium nitride (GaN) HEMT (high electron mobility transistors) to operate at the 10× increase in switching frequency with improved controller stability when compared to conventional gallium nitride (GaN) HEMT (high electron mobility transistors). Additionally, the iTank ADC allows a physical size of a main transformer of a microinverter (and some other passive filter components) to be reduced by a factor of approximately 3×, which, in turn, can provide decreased manufacturing costs.

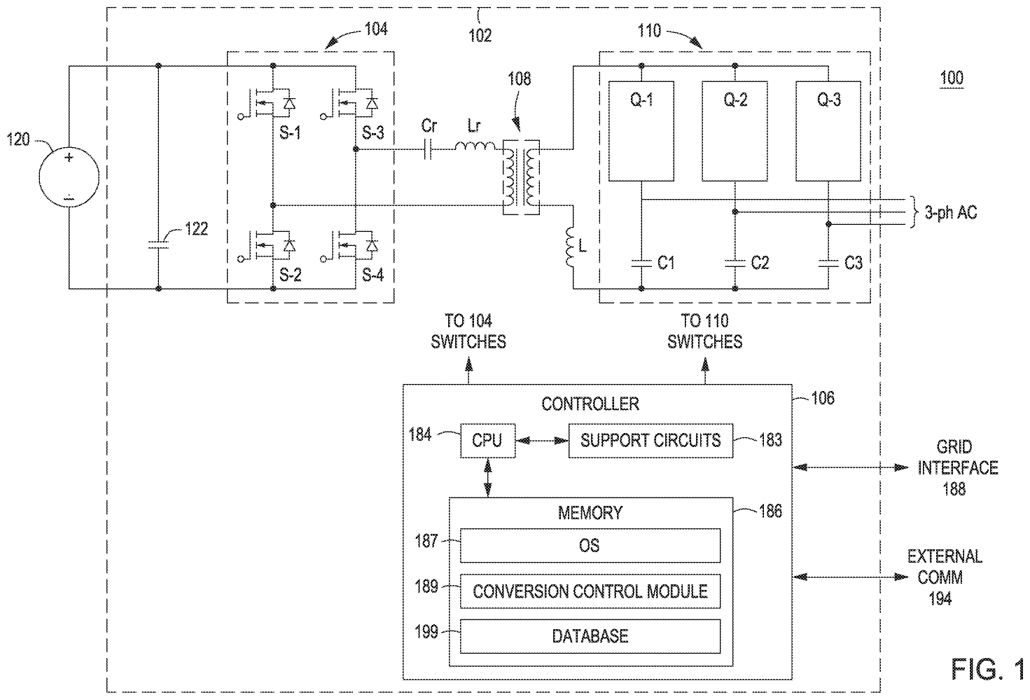

FIG. 1 is a schematic diagram of a power conversion system 100 comprising a power converter 102 (e.g., a switched mode power converter) in accordance with embodiments of the present disclosure. This diagram only portrays one variation of the myriad of possible system configurations. The present disclosure can function in a variety of power generation environments and systems.

The power conversion system 100 comprises a DC component 120, such as a PV module or a battery, coupled to a DC side of the power converter 102. In other embodiments the DC component 120 may be any suitable type of DC components, such as another type of renewable energy source (e.g., wind farms, hydroelectric systems, and the like), other types of energy storage components, and the like.

The power converter 102 comprises a capacitor 122 coupled across the DC component 120 as well as across an H-bridge 104 formed from switches S-1, S-2, S-3 and S-4. The switches S-1 and S-2 are coupled in series to form a left leg of the H-bridge 104, and the switches S-3 and S-4 are coupled in series to form a right leg of the H-bridge 104.

The output of the H-bridge 104 is coupled across a series combination of a capacitor Cr and inductor L, which form a resonant tank, and the primary winding of a transformer 108. In other embodiments, the resonant tank may be formed by a different configuration of the capacitor Cr and the inductor Lr (e.g., the capacitor Cr and the inductor L may be coupled in parallel); in some embodiments, Lr may represent a leakage inductance from the transformer 108 rather than a physical inductor.

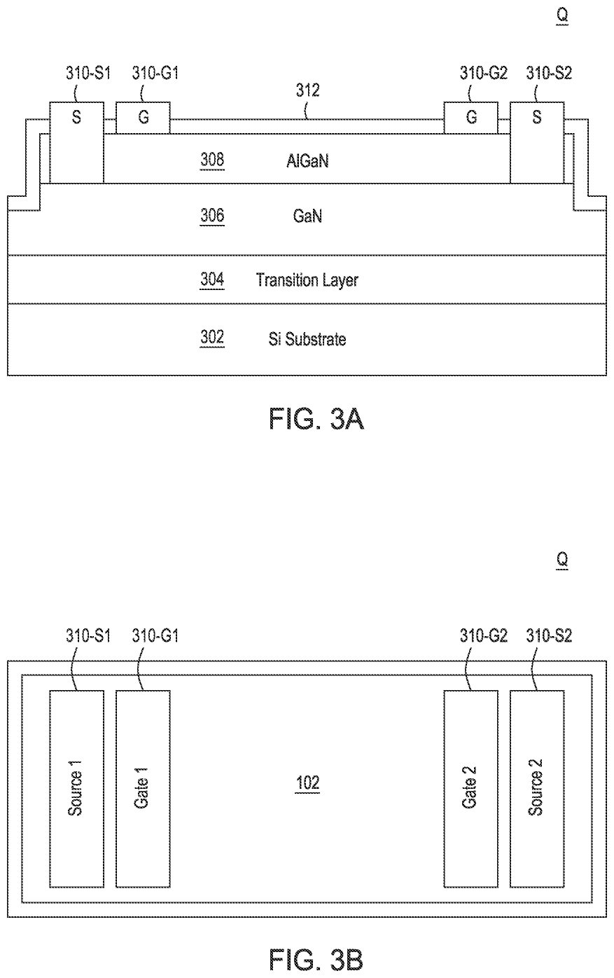

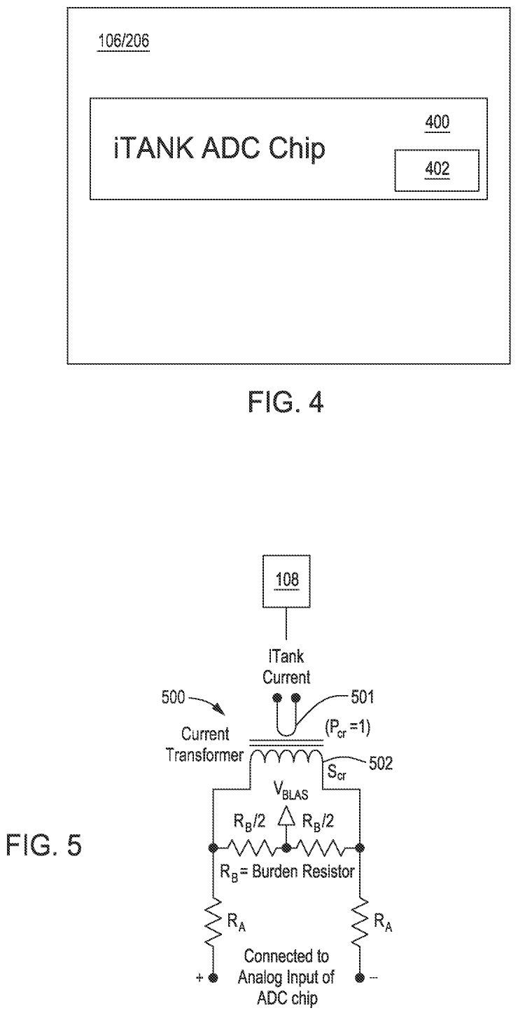

A series combination of the secondary winding of the transformer 108 and an inductor L is coupled across a cycloconverter 110 which produces a three-phase AC output, although in other embodiments the cycloconverter 110 may produce one or two phases of AC at its output. The cycloconverter 110 comprises three 4 Q bi-directional switches Q-1, Q-2, and Q-3 (which may be collectively referred to as switches Q) respectively in a first leg, a second leg, and a third leg coupled in parallel to one another. In accordance with embodiments of the present disclosure, each of the switches Q-1, Q-2, and Q-3 is a native four quadrant bi-directional switch, described in detail further below with respect to FIGS. 3A and 3B.

The first cycloconverter leg comprises the 4 Q switch Q-1 coupled to a capacitor C1, the second cycloconverter leg comprises the 4 Q switch Q-2 coupled to a capacitor C2, and the third cycloconverter leg comprises a 4 Q switch Q-3 coupled to a capacitor C3. A first AC output phase line is coupled between the switch Q-1 and the capacitor C1, a second AC output phase line is coupled between the switch Q-2 and the capacitor C2, and a third AC output phase line is coupled between the switch Q-3 and the capacitor C3. The power converter 102 may also include additional circuitry not shown, such as voltage and/or current monitors, for obtaining data for power conversion, data reporting, and the like.

The power converter 102 additionally comprises a controller 106 coupled to the H-bridge switches (S-1, S-2, S-3, and S-4) and the cycloconverter switches (Q-1, Q-2, and Q-3) for operatively controlling the switches to generate the desired output power. In some embodiments, the power converter 102 may function as a bi-directional converter.

The controller 106 comprises a CPU 184 coupled to each of support circuits 183 and a memory 186. The CPU 184 may comprise one or more conventionally available microprocessors or microcontrollers. Additionally or alternatively, the CPU 184 may include one or more application specific integrated circuits (ASICs). The support circuits 183 are well known circuits used to promote functionality of the CPU 184. Such circuits include, but are not limited to, a cache, power supplies, clock circuits, buses, input/output (I/O) circuits, and the like. The controller 106 may be implemented using a general purpose computer that, when executing particular software, becomes a specific purpose computer for performing various embodiments of the present disclosure.

The memory 186 is a non-transitory computer readable medium such as random access memory, read only memory, removable disk memory, flash memory, and various combinations of these types of memory. The memory 186 is sometimes referred to as main memory and may, in part, be used as cache memory or buffer memory. The memory 186 generally stores the OS 187 (operating system), if necessary, of the controller 106 that can be supported by the CPU capabilities. In some embodiments, the OS 187 may be one of a number of commercially available operating systems such as, but not limited to, LINUX, Real-Time Operating System (RTOS), and the like.

The memory 186 may store various forms of application software, such as a conversion control module 189 for controlling power conversion by the power converter 102, for example maximum power point tracking (MPPT), switching, and the like. The memory 186 may further store a database 199 for storing various data. The controller 106 further processes inputs and outputs to external communications 194 (i.e., gateway) and a grid interface 188.

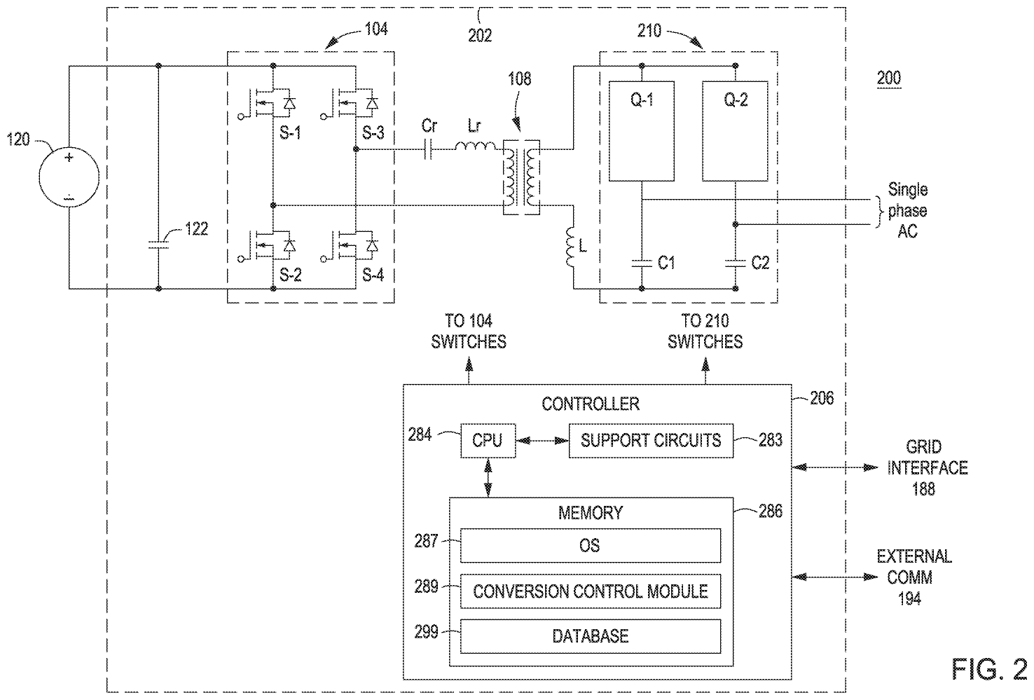

FIG. 2 is a schematic diagram of a power conversion system 200 comprising a power converter 202 (e.g., a switched mode power converter) in accordance with embodiments of the present disclosure.

The power conversion system 200 comprises the DC component 120 coupled to a DC side of the power converter 202 (referred to herein as “converter 202”). The converter 202 comprises the capacitor 122 coupled across the DC component 120 and the H-bridge 104, as described above with respect to the power converter 102. The output of the H-bridge 104 is coupled across a series combination of the capacitor Cr and the inductor Lr, which form a resonant tank, and the primary winding of the transformer 108, as described above with respect to the power converter 102. In other embodiments, the resonant tank may be formed by a different configuration of the capacitor Cr and the inductor Lr (e.g., the capacitor Cr and the inductor L may be coupled in parallel); in some embodiments, Lr may represent a leakage inductance of the transformer 108 rather than a physical inductor.

A series combination of the secondary winding of the transformer 108 and the inductor L is coupled across a cycloconverter 210 which produces a single-phase AC output. The cycloconverter 210 comprises two bi-directional switches Q-1 and Q-2, (collectively referred to as switches Q) respectively in a first leg and a second leg coupled in parallel to one another. In accordance with embodiments of the present disclosure, each of the switches Q-1 and Q-2 is a native four quadrant bi-directional switch, described in detail further below with respect to FIGS. 3A and 3B.

The first cycloconverter leg comprises the 4 Q switch Q-1 coupled to the capacitor C1, and the second cycloconverter leg comprises the 4 Q switch Q-2 coupled to the capacitor C2. A first AC output phase line is coupled between the switch Q-1 and the capacitor C1, and a second AC output phase line is coupled between the switch Q-2 and the capacitor C2. The power converter 202 may also include additional circuitry not shown, such as voltage and/or current monitors, for obtaining data for power conversion, data reporting, and the like.

The power converter 202 additionally comprises a controller 206 coupled to the H-bridge switches (S-1, S-2, S-3, and S-4), and the cycloconverter switches (Q-1 and Q-2) for operatively controlling the switches to generate the desired output power. In some embodiments, the power converter 202 may function as a bi-directional converter.

The controller 206 comprises a CPU 284 coupled to each of support circuits 283 and a memory 286. The CPU 284 may comprise one or more conventionally available microprocessors or microcontrollers. Additionally or alternatively, the CPU 284 may include one or more application specific integrated circuits (ASICs). The support circuits 283 are well known circuits used to promote functionality of the CPU 284. Such circuits include, but are not limited to, a cache, power supplies, clock circuits, buses, input/output (I/O) circuits, and the like. The controller 206 may be implemented using a general purpose computer that, when executing particular software, becomes a specific purpose computer for performing various embodiments of the present disclosure.

The memory 286 is a non-transitory computer readable medium such as random access memory, read only memory, removable disk memory, flash memory, and various combinations of these types of memory. The memory 286 is sometimes referred to as main memory and may, in part, be used as cache memory or buffer memory. The memory 286 generally stores the OS 287 (operating system), if necessary, of the controller 206 that can be supported by the CPU capabilities. In some embodiments, the OS 287 may be one of a number of commercially available operating systems such as, but not limited to, LINUX, Real-Time Operating System (RTOS), and the like.

The memory 286 may store various forms of application software, such as a conversion control module 289 for controlling power conversion by the power converter 202, for example maximum power point tracking (MPPT), switching, and the like. The memory 286 may further store a database 299 for storing various data. The controller 206 further processes inputs and outputs to external communications 194 (i.e., gateway) and the grid interface 188.

FIG. 3A is a cross-sectional view depicting a structure of the switch Q in accordance with one or more embodiments of the present disclosure. The switch Q is a gallium nitride (GaN) high electron mobility transistor (HEMT) structure comprising layers 302, 304, 306, 308, and 312 with source terminals 310-S-1/310-S-2 and gate terminals 310-G1/310-G2 coupled to the layer 308. In contrast to a conventional uni-directional GaN HEMT switch, which is fabricated as a lateral device with a drift region between drain and source connections being parallel to the top surface of the GaN die, the switch Q comprises two gate-source structures (one of which is used in place of the drain structure of the conventional uni-directional GaN HEMT switch) to facilitate the native four quadrant bi-directional switch Q. As such, the switch Q allows the common drift region to be used in either direction (i.e., for current flowing in the direction from the source terminal 310-S-1 to the source terminal 310-S-2, or for current flowing in the direction from the source terminal 310-S-2 to the source terminal 310-S-1) and block either a positive or a negative voltage, thereby providing a GaN area reduction as compared to a conventional 4 Q device fabricated by connecting two conventional GaN HEMT devices together. In various embodiments, the switch Q may have a die area that is half of the die area of a conventional uni-directional GaN HEMT and thus provide a 4:1 die area advantage as compared to a pair of conventional uni-directional GaN HEMTs connected together to form a 4 Q device. Further, the ratio of gate drive loss to conduction loss ratio (i.e., Q_{G}/R_{SS-ON}) for the switch Q is two times lower than for a GaN 4 Q switch constructed out of two conventional uni-directional GaN HEMT devices due to the 2:1 die area per switch difference (only one of the gates 310-G1, 310-G2 is switched at any given time).

As depicted in FIG. 3A, the layer 302 (e.g., a base layer) is a silicon (Si) substrate, typically on the order of 0.7 mm thick. The layer 304, which is sandwiched between the layers 302 and 306, is a transition layer (which in some embodiments may comprise two or more different elements), typically on the order of a few nano-meters thick. The layer 306, which is sandwiched between the layers 304 and 308, is a gallium nitride (GaN) layer, typically on the order of a few micro-meters thick. The layer 308, atop the layer 306, is an aluminum gallium nitride (AlGaN) layer, typically on the order of a few micro-meters thick. The layer 312, which sits atop the layer 308, is an inert passivation layer (e.g., a glass-like deposited layer) that is used to prevent impurities from the environment from leaching into the structure of the switch Q.

The source terminals 310-S-1/310-S-2 are typically thin metal layers with composition known in the art to make ohmic contact to the layer 308, and the gate terminals 310-G1/310-G2 are typically thin metal layers with composition known in the art that produce a Schottky contact to the layer 308.

In some alternative embodiments, other types of materials and/or structures may be used for the switch Q. For example, wide bandgap materials other than GaN, such as silicon carbide, may be utilized, and/or a structure other than the HEMT structure, such as a metal-oxide-semiconductor field-effect transistor (MOSFET) structure, may be used.

Examples of the switch Q may be found in commonly assigned U.S. Pat. No. 9,130,570, titled “Four Quadrant Bidirectional Switch”, which is herein incorporated by reference in its entirety.

FIG. 3B is a plan view of the switch Q in accordance with embodiments of the present disclosure. The plan view of the switch Q depicts the source and gate terminals 310-S-1 and 310-G1 located near one another at one end of the top of the switch Q, and the source and gate terminals 310-S-2 and 310-G2 located near one another at the opposite end of the top of the switch Q.

The foregoing description of embodiments of the disclosure comprises a number of elements, devices, circuits and/or assemblies that perform various functions as described. These elements, devices, circuits, and/or assemblies are exemplary implementations of means for performing their respectively described functions.

As noted above, the controller (e.g., the controller 106 and the controller 206) can use custom application specific integrated circuits (ASIC) in place of or in addition to a CPU (e.g., the CPU 284). For example, a Hybrid ADC chip 400 (e.g., a low latency Hybrid ADC) is predicated on a main control ASIC that uses a Kalman Filter as part of the main control ASIC control loop logic. For example, a Kalman Filter uses a mathematical model of a system that the Kalman Filter is to control based on a physics relating to the main control ASIC. In this way, a Kalman Filter is able to employ statistical analysis to determine a most statistical probable state of the system that the Kalman Filter is trying to model and control. With this purpose in mind, the controller includes a system model 402 that is referred to as a state space observer (SSO) which represents the statistically most probable state of the converter—the SSO among other parameters is able to provide the most statistically probable value for an iTank current. Thus, during operation, the SSO is able to predict the iTank current over a complete switching cycle with approximately 0.1% RMS error and an absolute error less than ±1%. The availability of the very accurate estimation of the iTank current eliminates a need for using a successive approximation method for determining the iTank current. Rather than starting with a 1^{st} approximation based on 50% (which is a value used in a SAR ADC), the new Hybrid ADC uses the value from the SSO as the 1^{st} approximation. Based on the ±1% peak error inherent in this SSO approximation of the iTank current the first 6 successive approximations (i.e., resolving the first 6-bits) can be eliminated, and on average the first 9 successive approximations (i.e., resolving the first 9-bits) can be eliminated (e.g., based on a switching cycle average of 0.1% RMS error).

Rather than employing a SAR concept to resolve the remaining bits for the ADC conversion, the Hybrid ADC design described herein employs a simple up/down delta conversion strategy. For example, a comparator compares the SSO iTank approximation to the real iTank input signal to determine if the SSO approximation is too high or too low and then, based on the result of the comparison, a counter is either incremented or decremented. The output of the counter is added to the initial SSO iTank approximation to result in a second approximation that will be one count closer to the final correct value.

The Hybrid ADC chip can be operated in coordination with an external SSO which is able to predict the iTank current with a high degree of precision. For example, as noted above, the external SSO can predict the iTank current within about 1% and can maintain an average RMS error of about 0.1% over the iTank signal period (e.g., about 4 μs to about 10 μs).

The Hybrid ADC chip 400 can be a self-contained stand-alone chip that is configured to connect to an external SSO. Alternatively, the Hybrid ADC chip 400 and an SSO can be integrated into a larger control ASIC (e.g., silicon implementation) that will contain the Hybrid ADC chip, the SSO, and other several other control system blocks.

A binary up/down counter can be used as a two's compliment binary counter. The binary up/down counter can be designed so as not to roll over from 7 FF to 800 (or from 800 to 7 FF), but simply saturate at a minimum or maximum count values. The output from the binary up/down counter can be fed as one input to a summing block. The last value of the counter prior to the rising edge of an MHz LVDS interface input clock (e.g., LVDS interface synchronization) can be latched into an output register for the data output bus. A counter resolution 4-bit register can be used to adjust a step size of the binary up/down counter in 2ⁿ steps. Increasing the binary up/down counter step size can be, for example, equivalent to bit shifting the binary up/down counter output and can provide a control that allows an effective number of bits for the Hybrid ADC chip 400 to be adjusted (e.g., a trade-off between slew rate and resolution).

FIG. 5 is a schematic diagram of a current transformer 500 (e.g., an external current transformer) and external bias resistors in accordance with one or more embodiments of the present disclosure. FIG. 5 shows the detail of the current transformer 500 and the associated bias resistors that are used to connect the current transformer to the analog input of the Hybrid ADC chip. A primary winding 501 of the current transformer 500 can be a single turn winding (POT) that carries the resonant tank current (iTank) that the Hybrid ADC chip 400 is measuring. For example, the primary winding 501 of the current transformer 500 couples to (e.g., passes through) at least one of the secondary windings of the transformer 108 so that as current flows through the secondary windings of the transformer that current can be fed through and measured by the Hybrid ADC chip 400. A secondary winding 502 (S_{CT}) of the current transformer 500 can be typically wound with about 50 turns, which results in a 1:50 turns ratio resulting in a secondary current that is 1/50 of the primary iTank current. The secondary current from the current transformer 500 flows primarily through a burden resistor R_{B} which generates a voltage that is proportional to the iTank current signal. The burden resistor R_{B} is shown split into two equal valued resistors R_{B} which allows a bias voltage V_{Bias} to be applied to the mid-point to bias a current flow into the current sink differential outputs of a current steering digital to analog converter (DAC). The current steering DAC provides current source outputs that require the mid-point of the burden resistor R_{B} to be connected to the current steering DAC ground. Two bias resistors R_{A} allow the output of the current steering DAC to be correctly biased to operate over the bias resistors R_{A} specified linear operating voltage. The combination of the bias resistors R_{A} and the burden resistors R_{B} forms a current divider which allows the output from the current transformer 500 to be correctly scaled to match the same scaling as the current steering DAC output. The combination of the current transformer 500, bias resistors R_{A} and the burden resistors R_{B}, and the current steering DAC form a differential current balance circuit which balances the differential output from the current transformer 500 against the differential output from the current steering DAC. The imbalance resulting from the differential current balance results in a voltage that is monitored by the comparator. The polarity of the comparator voltage indicates which of the two differential currents is the larger and which is the smaller.

In at least some embodiments, the values for bias resistors R_{A} and the burden resistors R_{B} and the V_{Bias} can be calculated based on the following formulas (e.g., a unity scaling). P_{CT}=Number of primary turns for current transformer 500 (normally 1), S_{CT}=Number of secondary turns for current transformer 500 (typically 50 turns), R_{B}=is the total resistance value for the bias resistor (actually implemented as two resistors of equal value equal to R_{B}/2), i_{PK}=Peak iTank current, DAC_{Out-Vpp}=Current steering DAC peak-to-peak output voltage (maximum recommended value that the current steering DAC design can support), DAC_{Full-scale}=Current steering DAC full scale differential output current, DAC_{Voffset}=Current steering DAC differential output offset voltage bias (mid-point voltage) to bias current sink outputs into their linear operating range, DAC_{ioffset}=Current steering DAC differential output offset current bias (mid-point current) to bias current sink outputs into their linear operating range, V_{Bias}=the bias voltage applied to the mid-point of R_{B} in order to bias the output of the current steering DAC into its linear operating range. With the aforementioned formulas, the values for the bias resistors R_{A} and the burden resistors R_{B} and the V_{Bias} can be calculated using the following three Equations (1) to (3):

R_{A}=(DAC_{Out-Vpp}/(2×DAC_{Full-scale})), (1)

R_{B}=((DAC_{Out-Vpp}×S_{CT})/(2×i_{PK}×P_{CT})), (2) and

V_{Bias}=(DAC_{Voffset}+DAC_{ioffset}×R_{A}). (3)

The above calculations determine the correct values for the bias resistors R_{A} and the burden resistors R_{B} based on unity gain. A higher gain can be added which will have the same effect as adding an amplifier with the same gain between the output of the current steering DAC (e.g., after where the bias resistors R_{A} connect) and the input of the comparator. The gain can be applied by scaling the values for the bias resistors R_{A} and the burden resistors R_{B} by the desired gain value (the value for V_{Bias} can be changed according to the scaled value of the bias resistors R_{A}—thus imposing a practical limit on how much gain can be applied. Adding the gain can have a significant impact on the system power losses. For example, the power loss associated with the current transformer 500 and associated burden resistor R_{B} can be given by the by Equation (4):

Power Loss=((R_{B}×(i_{PK}×P_{CT})²)/(2×(S_{CT})²)) (4)

The above assumes that the iTank current signal is a sinewave and, hence, the iTank current signal RMS current is 0.7071 of the i_{PK} current value. The Equation (4) shows that if gain is added by simply scaling the values for the bias resistors R_{A} and the burden resistors R_{B}, the power loss will also scale up according to the applied gain. The current transformer 500 and the burden resistor R_{B} can be scaled up in size to dissipate the power loss. Adding an actual amplifier with gain between the output of the current steering DAC and the comparator can achieve the same result without such a significant impact on the system power loss.

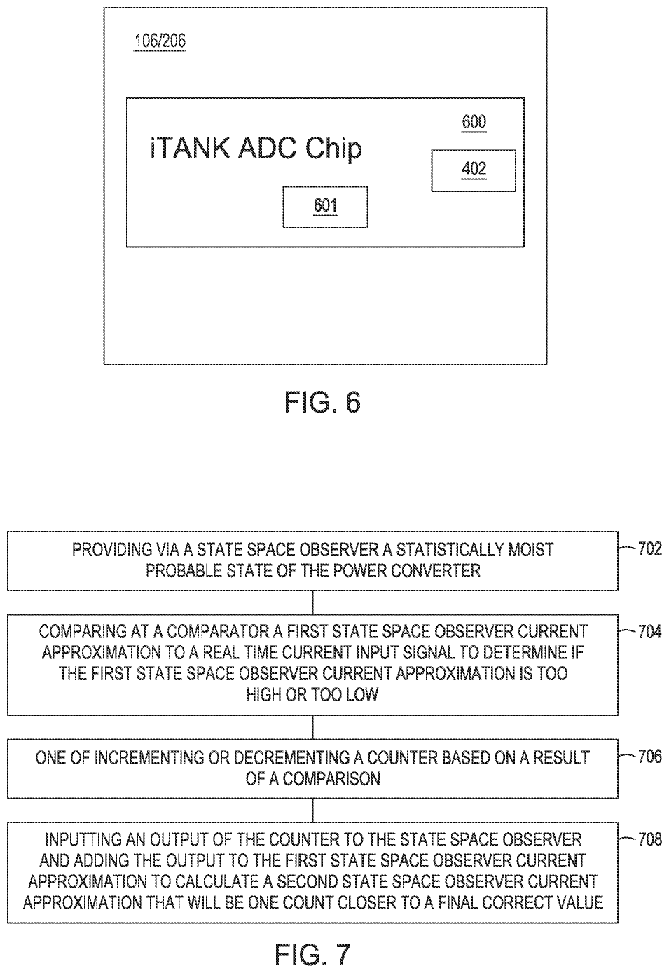

FIG. 6 is a schematic diagram of a Hybrid ADC chip 600 for measuring current in accordance with one or more embodiments of the present disclosure.

The Hybrid ADC chip 600 replaces the need for a PLL clock, the comparator, the binary up/down counter, and the summing block described above with respect to the Hybrid ADC chip 600 by using a flash conversion ADC 601 (e.g., a 6-bit flash conversion ADC). The Hybrid ADC chip 600 allows the current steering DAC to operate at a lower sample rate (e.g., 100 MS/sec) to meet timing requirements. For example, assuming the current steering DAC is a 12-bit with a differential 1 Vpp output, the flash conversion ADC 601 can be 6-bit with a differential full-scale input of about 15.625 mV (or alternatively an amplifier with a ×64 gain followed by the flash conversion ADC 601 with a full-scale differential input range of 1 Vpp).

The hybrid ADC chip 600 can be imminently scale-able to operate at a much higher sample rate and provide a much lower latency, e.g., can be scaled up to operate at 1 GS/sec and provide a 1 ns sampling latency.

The foregoing description of embodiments of the disclosure comprises a number of elements, devices, circuits and/or assemblies that perform various functions as described. These elements, devices, circuits, and/or assemblies are exemplary implementations of means for performing their respectively described functions.

FIG. 7 is a flowchart of a method 700 in accordance with embodiments of the present disclosure. For example, at 702, the method 700 comprises providing via a state space observer a statistically most probable state of the power converter. Next, at 704, the method 700 comprises comparing at a comparator a first state space observer current approximation to a real time current input signal to determine if the first state space observer current approximation is too high or too low. Next, at 706, the method 700 comprises one of incrementing or decrementing a counter based on a result of a comparison, Next, at 708, the method 700 comprises inputting an output of the counter to the state space observer and adding the output to the first state space observer current approximation to calculate a second state space observer current approximation that will be one count closer to a final correct value.

While the foregoing is directed to embodiments of the present disclosure, other and further embodiments of the disclosure may be devised without departing from the basic scope thereof, and the scope thereof is defined by the claims that follow.

1. An apparatus for measuring current in a power converter comprising:
a state space observer configured to provide a statistically most probable state of the power converter; and
an analog digital converter comprising:
a comparator configured to compare a first state space observer current approximation to a real time current input signal to determine if the first state space observer current approximation is too high or too low; and
a counter configured to be incremented or decremented based on a result of a comparison at the comparator,
wherein an output of the counter is input to the state space observer and added to the first state space observer current approximation to calculate a second state space observer current approximation that will be one count closer to a final correct value.

2. The apparatus of claim 1, further comprising an external current transformer configured to provide an external current transformer differential output to the comparator and a current steering digital to analog converter configured to provide a current steering digital to analog converter differential output to the comparator.

3. The apparatus of claim 2, wherein an imbalance between the external current transformer differential output and the current steering digital to analog converter differential output results in a voltage that is monitored by a voltage comparator, and wherein a polarity of the voltage indicates which of the external current transformer differential output and the current steering digital to analog converter differential output is the larger and which is the smaller.

4. The apparatus of claim 1, wherein the state space observer and the analog digital converter are disposed on the same application specific integrated circuit.

5. The apparatus of claim 1, wherein the state space observer is external to the analog digital converter.

6. A method for measuring current in a power converter comprising:
providing via a state space observer a statistically most probable state of the power converter;
comparing at a comparator a first state space observer current approximation to a real time current input signal to determine if the first state space observer current approximation is too high or too low;
one of incrementing or decrementing a counter based on a result of a comparison; and
inputting an output of the counter to the state space observer and adding the output to the first state space observer current approximation to calculate a second state space observer current approximation that will be one count closer to a final correct value.

7. The method of claim 6, further comprising an external current transformer configured to provide an external current transformer differential output to the comparator and a current steering digital to analog converter configured to provide a current steering digital to analog converter differential output to the comparator.

8. The method of claim 7, wherein an imbalance between the external current transformer differential output and the current steering digital to analog converter differential output results in a voltage that is monitored by a voltage comparator, and wherein a polarity of the voltage indicates which of the external current transformer differential output and the current steering digital to analog converter differential output is the larger and which is the smaller.

9. The method of claim 6, wherein the state space observer and an analog digital converter are disposed on the same application specific integrated circuit.

10. The method of claim 6, wherein the state space observer is external to an analog digital converter.
